(19) United States
(12) Patent Application Publication
(10) Pub. No.: US 2025/0086437 A1
(43) Pub. Date: Mar. 13, 2025

(54) OPERATING SYSTEM AND METHOD OF A FULLY HOMOMORPHIC ENCRYPTION NEURAL NETWORK MODEL

(71) Applicants: INVENTEC (PUDONG) TECHNOLOGY CORPORATION, Shanghai (CN); INVENTEC CORPORATION, Taipei City (TW)

(72) Inventors: Tzu-Li LIU, Taipei City (TW); Yu-Te KU, Taipei City (TW); Ming-Chien HO, Taipei City (TW); Chih-Fan HSU, Taipei City (TW); Wei-Chao CHEN, Taipei City (TW); Feng-Hao LIU, Taipei City (TW); Ming-Ching CHANG, Taipei City (TW); Shih-Hao HUNG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/545,775

(22) Filed: Dec. 19, 2023

(30) Foreign Application Priority Data
Sep. 12, 2023 (CN) 202311172041.4

(51) Int. Cl. G06N 3/0464; G06N 3/048; H04L 9/00

(52) U.S. Cl. CPC G06N 3/0464; G06N 3/048; H04L 9/008

(57) ABSTRACT

An operating method of a fully homomorphic encrypted neural network model is provided, wherein the fully homomorphic encrypted neural network model includes a plurality of layers, and the method performed by a processor includes: for one of the plurality of layers, encrypting a plaintext input with a first encryption algorithm to generate a ciphertext vector, performing a convolution operation according to the ciphertext vector to generate a result vector, transforming the result vector into a plurality of result ciphertexts adopting a second encryption algorithm, inputting the plurality of result ciphertexts into an activation function to generate a plurality of encrypted activation values, and repacking the plurality of encrypted activation values to generate an output vector adopting the first encryption algorithm.

### CROSS-REFERENCE TO RELATED APPLICATIONS

This non-provisional application claims priority under 35 U.S.C. § 119(a) on Patent Application No(s). 202311172041.4 filed in China on Sep. 12, 2023, the entire contents of which are hereby incorporated by reference.

### BACKGROUND

### 1. Technical Field

The present disclosure relates to fully homomorphic encryption and neural networks, and more particular to an operating system and method of a fully homomorphic encryption neural network model.

### 2. Related Art

Machine Learning as a Service (MLaaS) allows users to upload data for inference on neural network models running on cloud platforms. While MLaaS is highly convenient, the issue of maintaining data privacy has become significant, as users' private data is submitted or stored in external environments.

Fully Homomorphic Encryption (FHE) enables direct computation on encrypted data. In other words, neural network (NN) models do not need to access the raw data during computation, ensuring user data privacy. Currently, there are two commonly used FHE schemes for encrypting neural network inference: CKKS and FHEW/TFHE. The CKKS scheme supports floating-point operations, making it efficient for linear computations. However, it does not support non-polynomial operations. FHEW/TFHE supports lightweight bit-wise or integer operations and includes functional bootstrapping technology to achieve non-polynomial operations. Therefore, by combining the advantages of CKKS for linear operations and FHEW/TFHE for functional bootstrapping, it seems possible to apply them in encrypted neural network models. However, existing experimental data demonstrates a significant decrease in the inference accuracy of neural network models built by simply combining these two encryption schemes.

### SUMMARY

In light of the above descriptions, the present disclosure provides an operating system and method of a FHE NN model to address the issue of reduced inference accuracy in neural network models that arise from simply combining the CKKS and FHEW/TFHE schemes.

According to one or more embodiment of the present disclosure, an operating method of a fully homomorphic encrypted neural network model is provided. The fully homomorphic encrypted neural network model includes a plurality of layers, and the method is performed by a processor and includes: for one of the plurality of layers, encrypting a plaintext input with a first encryption algorithm to generate a ciphertext vector; performing a convolution operation according to the ciphertext vector to generate a result vector; converting the result vector into a plurality of result ciphertexts adopting a second encryption algorithm; inputting the plurality of result ciphertexts into an activation function to generate a plurality of encrypted activation values; and repacking the plurality of encrypted activation values to generate an output vector adopting the first encryption algorithm.

According to one or more embodiment of the present disclosure, an operating system of a fully homomorphic encrypted neural network model includes a memory and a processor. The memory is configured to store a plurality of instructions. The processor is electrically connected to the memory to execute the plurality of instructions, wherein the plurality of instructions is configured to perform a plurality of operations on one of a plurality of layers of the fully homomorphic encrypted neural network model, and the plurality of operations includes: encrypting a plaintext input with a first encryption algorithm to generate a ciphertext vector; performing a convolution operation according to the ciphertext vector to generate a result vector; converting the result vector into a plurality of result ciphertexts adopting a second encryption algorithm; inputting the plurality of result ciphertexts into an activation function to generate a plurality of encrypted activation values; and repacking the plurality of encrypted activation values to generate an output vector adopting the first encryption algorithm.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the operating system of a fully homomorphic encryption neural network model according to an embodiment of the present disclosure;

FIG. 2 is a flowchart of the operating method of a fully homomorphic encryption neural network model according to an embodiment of the present disclosure;

FIG. 3 is a schematic diagram of the operating method of a fully homomorphic encryption neural network model according to an embodiment of the present disclosure;

FIG. 4(a) and FIG. 4(b) are illustrative diagrams of range alignment examples;

FIG. 5 is a flowchart of the fine-tuning method for a lookup table-aware model according to an embodiment of the present disclosure; and

FIG. 6 is a detailed flowchart of the training procedure in FIG. 5.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

FIG. 1 is a block diagram of the operating system of a fully homomorphic encryption neural network model according to an embodiment of the present disclosure. As shown in FIG. 1, the operating system 10 includes a memory 1 and a processor 3 electrically connected to the memory 1.

The memory 1 is configured to store a plurality of instructions. In an embodiment, the memory 1 may be implemented as one or more of the following examples: Dynamic Random Access Memory (DRAM), Static Random Access Memory (SRAM), Double Data Rate Synchronous Dynamic Random Access Memory (DDR SDRAM), flash memory, and hard drive. The present disclosure does not limit the type or quantity of the memory 1.

The processor 3 is configured to execute the plurality of instructions stored in memory 1. In an embodiment, the processor 3 may be implemented as one or more of the following examples: personal computer, network server, microcontroller (MCU), application processor (AP), field-programmable gate array (FPGA), Application-Specific Integrated Circuit (ASIC), system-on-a-chip (SOC), and deep learning accelerator. The present disclosure does not limit the type or quantity of the processor 3.

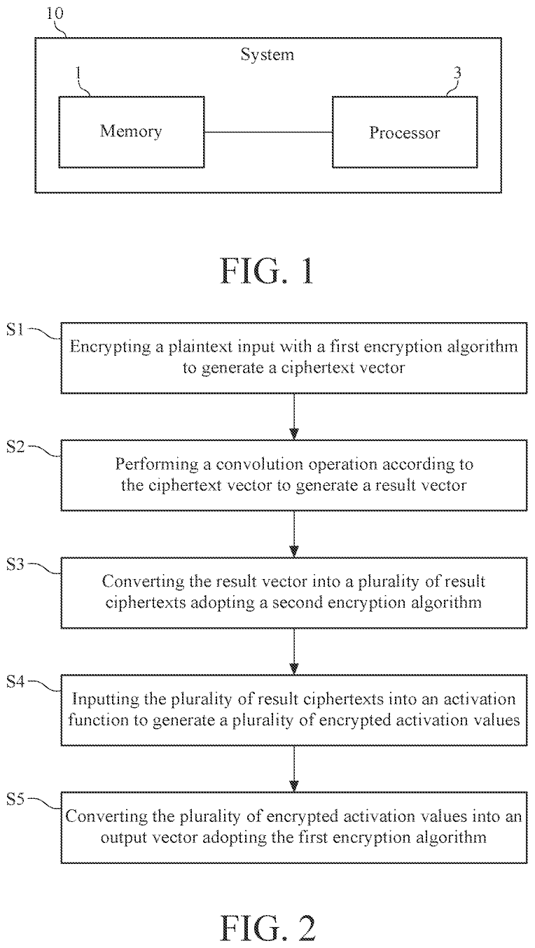

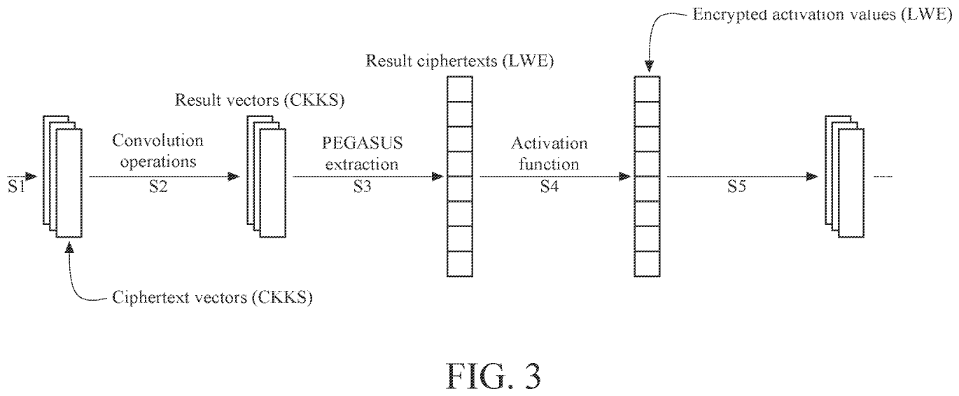

The fully homomorphic encryption neural network model includes a plurality of layers, and the plurality of instructions is configured to perform the process shown in FIG. 2 on one of the layers. FIG. 2 is a flowchart of the operating method of a fully homomorphic encryption neural network model according to an embodiment of the present disclosure, including steps S1 to S5. FIG. 3 is a schematic diagram of the operating method of a fully homomorphic encryption neural network model according to an embodiment of the present disclosure, illustrating the inputs, outputs, and corresponding operations for each step in FIG. 2.

In step S1, encrypting a plaintext input with a first encryption algorithm to generate a ciphertext vector.

In an embodiment, the first encryption algorithm is the Cheon-Kim-Kim-Song (CKKS) algorithm, which can be referenced in “Cheon, J. H., Kim, A., Kim, M., Song, Y.: Homomorphic encryption for arithmetic of approximate numbers. In: ASIACRYPT. pp. 409-437. Springer (2017).” CKKS supports arithmetic operations on floating-point vectors. During encryption, the plaintext input (floating-point vector) is first encoded into a plaintext polynomial and then encrypted into a ciphertext vector. Therefore, the operation in step S1 can be represented as CKKS(m)=Enc(Ecd(m)), where m∈Rⁿ denotes the plaintext input, Ecd(·) denotes the encoding operation, and Enc(·) denotes the encryption operation.

Please note that step S1 is applicable to the first convolution layer executed in the neural network model. For an intermediate convolution layer in the neural network model, since the results from the previous layer are already in ciphertext form, step S1 should be omitted, and the process starts directly from step S2.

In step S2, performing a convolution operation according to the ciphertext vector to generate a result vector.

In an embodiment, the convolution operation may be represented as f_{CONV}′(x)=W′(x)+b′, where W′ denotes convolution weights, and b′ denotes bias. The operation in step S2 may be represented as CKKS.eval(f_{CONV′}, {ctx0, ctx1, . . . })={ctx′0, ctx′1, . . . }, where {ctx0, ctx1, . . . } denotes the ciphertext vector, and {ctx′0, ctx′1, . . . } represents the result vector.

CKKS supports the evaluation function CKKS.eval(f, ·), where the input is a plaintext function f and the arguments of f placed after f, such as the plaintext input m or ciphertext ctx∈CKKS(m). The operation is conducting the function with these these arguments in CKKS and returns ctx∈CKKS(f(·)). For example, CKKS.eval(+, ctx, v) returns ctx′∈CKKS(m+v).

In step S3, converting the result vector into a plurality of result ciphertexts adopting the second encryption algorithm.

In an embodiment, the second encryption algorithm is associated with Learning with Errors (LWE). The encryption operation of LWE can be represented as LWE [symbol] m [symbol] , where [symbol] · [symbol] represents rounding and encoding operations, and m∈R is a scalar.

There are two implementations of LWE: the first one is FHEW, as described in “Ducas, L., Micciancio, D.: Fhew: bootstrapping homomorphic encryption in less than a second. In: EUROCRYPT. pp. 617-640. Springer (2015)”; the second one is TFHE, as described in “Chillotti, I., Gama, N., Georgieva, M., Izabachène, M.: TFHE: fast fully homomorphic encryption over the torus. Journal of Cryptology 33(1), 34-91 (2020).”

The conversion operation mentioned in step S3 applies PEGASUS, which is a framework for converting between CKKS ciphertext and LWE ciphertext without decryption. Please refer to “jie Lu, W., Huang, Z., Hong, C., Ma, Y., Qu, H.: PEGASUS: Bridging polynomial and non-polynomial evaluations in homomorphic encryption. In: 2021 IEEE Symposium on Security and Privacy. pp. 1057-1073. IEEE Computer Society Press (May 2021).”

Therefore, Step S3 may be represented as pegasus.extract(ctx)={ctx′i}·ctx∈CKKS(m) represents the result vector, where m∈Rⁿ·{ctx′i }∈LWE( [symbol] mᵢ [symbol] ) represents the multiple result ciphertexts, where mᵢ∈m and 0≤i<n.

In step S4, inputting the plurality of result ciphertexts into the activation function to generate a plurality of encrypted activation values.

In an embodiment, the activation function is Rectified Linear Unit (ReLU). PEGASUS employs a fine-grained look-up table (LUT) approximation for evaluating non-polynomial functions such as ReLU. Step S4 may be represented as pegasus.eval(f_{ACT}, ctxᵢ)=ctx′ᵢ, where f_{ACT} denotes the activation function, ctxᵢ∈LWE( [symbol] mᵢ [symbol] ) denotes the plurality of result ciphertexts, and ctx′ᵢ∈LWE( [symbol] f_{ACT}′(mᵢ) [symbol] ) denotes the plurality of encrypted activation values.

In step S5, convert the plurality of encrypted activation values into an output vector adopting the first encryption algorithm.

In an embodiment, step S5 may be represented as pegasus.repack({ctx′ᵢ}=ctx, where ctx′ᵢ∈LWE( [symbol] mᵢ [symbol] ) denotes the plurality of encrypted activation values, and ctx∈CKKS(m) denotes the output vector.

It should be noted that simply combining the CKKS-FHEW/TFHE hybrid encryption inference framework and PEGASUS to implement a fully homomorphic encryption neural network model will result in a significant accuracy drop.

The accuracy drop is caused by the accumulated numerical errors throughout the encrypted neural network inference. The numerical errors are generated by the scale-down process in the PEGASUS framework that limits the numerical precision when applying regular functional bootstrapping on the large-domain ciphertexts.

FHEW supports functional bootstrapping, which is a type of bootstrapping used in homomorphic encryption operations to reduce error accumulation. It involves constructing a lookup table for a specific function, enabling efficiently computation of results. While it requires fewer bootstrapping iterations and less computations, it is effective only for supporting small message domains. If the requirement is to support large message domain, it results in a significant computational overhead.

The regular functional bootstrapping method can only be applied to LWE chiphertexts with a message domain limited to the size of the look-up table, typically around 2¹⁰. However, when dealing with LWE ciphertexts converted from CKKS ciphertexts, a larger message domain is usually required. To address this specific issue, PEGASUS introduces a groundbreaking technique known as large-domain functional bootstrapping. This technique involves scaling down the input ciphertext to a smaller message domain during the conversion from CKKS to FHEW, enabling the extension of regular functional bootstrapping to support a larger message domain. However, this expansion comes at the cost of reduced precision.

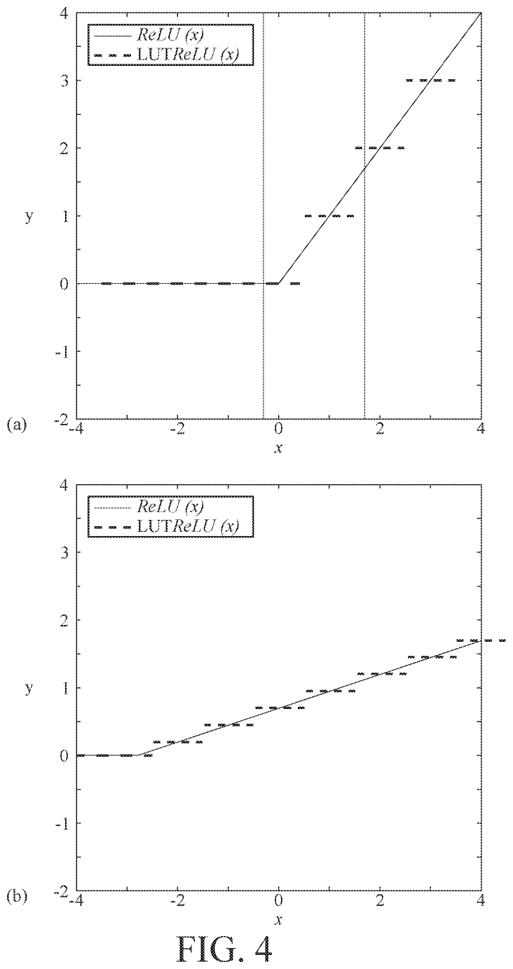

If the input value range of the LWE functional bootstrapping does not align with the predefined input domain of the LWE functional bootstrapping, either the input domain of the functional bootstrapping cannot fulfill the range of the input values or a few LUT entries are utilized. Please refer to FIG. 4(a) and FIG. 4(b). FIG. 4(a) illustrates the example that the predefined input domain of the LWE functional bootstrapping [−4, 4) is larger than the input value range [−0.3, 1.7). Only three LUT entries are used to map the input value x to the output y. The range mismatching generates a large numerical error when applying functional bootstrapping and then eventually affects the neural network model accuracy.

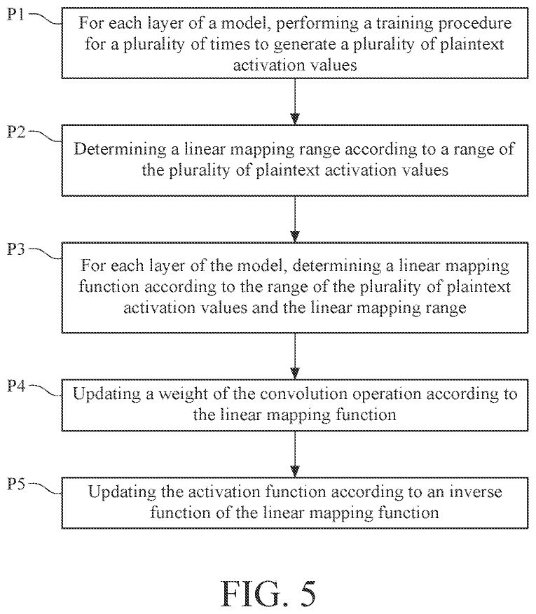

Therefore, the present disclosure designs a look-up table aware (LUT-aware) model fine-tuning method to align the range of the input value with the message domain of the ciphertext. The mismatch may be mitigated by aligning the input value with the LUT entry as shown in FIG. 4(b). Specifically, after constructing a fully homomorphic encryption neural network model according to a training dataset, it is necessary to adjust the model's weights and activation functions. Please refer to FIG. 5. FIG. 5 is a flowchart of the LUT-aware model fine-tuning method according to an embodiment of the present disclosure. The process of FIG. 5 occurs at least before step S2, “performing the convolution operation according to the ciphertext vector to generate the result vector”.

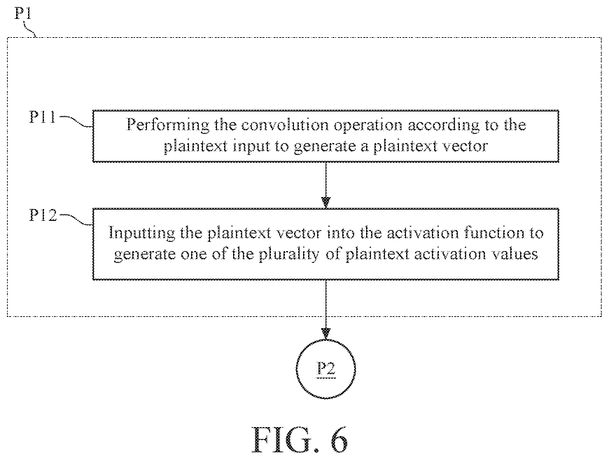

In step P1, for each layer of the model, performing a training procedure for a plurality of times to generate a plurality of plaintext activation values. FIG. 6 is a detailed flowchart of the training procedure in FIG. 5, which includes step P11, performing the convolution operation according to the plaintext input to generate a plaintext vector, and step P12, inputting the plaintext vector into the activation function to generate one of the plurality of plaintext activation values.

In step P2, determining a linear mapping range according to a range of the plurality of plaintext activation values.

In practical applications of fully homomorphic encryption neural network models, the input of the activation function (i.e., the result ciphertext) is encrypted, and the range of inputs of the activation function cannot be predetermined. Instead, it varies according to the input values of the neural network. The present disclosure assumes that the distribution of training data and testing data is similar. Therefore, to estimate the ranges of these inputs, in step P1, the trained model infers according to the plaintext inputs from the training dataset. During this process, the minimum and maximum values of the activation function output at each layer are observed and recorded, denoted as aᵢ and bᵢ, respectively. If [aᵢ, bᵢ) represents the output range of the activation function for the i-th layer, then the linear mapping range is set to [−B, +B), where B=max(|aᵢ|, |bᵢ|), and i=1, 2, . . . , n. In other words, the value of +B is greater than the maximum output value of each layer's activation function, and the value of −B is smaller than the minimum output value of each layer's activation function.

In step P3, for each layer of the model, determining a linear mapping function according to the range of the plurality of plaintext activation values and the linear mapping range. To illustrate how the linear mapping function is determined, let's consider a simple example, but the values used in the example are not limited. Suppose aᵢ=2, bᵢ=102, and B=1000. The linear mapping function is defined as: f(x)=(x−z)*s′, where z denotes the zero point, and s′ represents the scaling factor. The calculation of the parameters in the linear mapping function is as follows:
Output range: s=b−a=100
Zero point: z=(a+b)/2=52
Linear mapping range: S=B−(−B)=2000
Scaling factor: s′=S/s=20
A simple verification of the obtained linear mapping function, as derived above, f(x)=(x−52)*2000, is as follows:

$$\begin{matrix}f ( a ) = f ( 2 ) = ( 2 - 52 ) * 20 = - 1000 = - B \\ f ( b ) = f ( 102 ) = ( 102 - 52 ) / 20 = 1000 = B\end{matrix}$$

In step P4, updating the weight of convolution operation according to the linear mapping function.

Applying a linear map to the input may ensure that the input interval is aligned with the message domain. The linear mapping function may be incorporated into the convolution weights and bias, thereby avoiding any additional computational costs or memory usage. In an embodiment, step P4 may be represented as f_{CONV}′(x)= [symbol] _{LM}^{(a,b,B)}(f_{CONV}(x)), where f_{CONV}′(x) denotes the convolution operation with updated weights for step S2. [symbol] _{LM}^{(a,b,B)} denotes the linear mapping function that linearly maps the input x∈ [symbol] ⁿ with a range of [a, b) to a range of [−B, B). f_{CONV}(x) denotes the original convolution operation of the model built according to the training dataset. Here's a simple example to illustrate how the weights are updated:

Suppose the original convolution operation is represented as y=Wx+b, and the linear mapping function is represented as f(x)=(x−z)*s′, then

$$\begin{matrix}f ( y ) = ( Wx + b ) * s ’ - z * s ’ \\ = Wx * s ’ + b * s ’ - z * s ’ \\ = ( W * s ’ ) * x + ( b * s ’ - z * s ’ ) \\ = W ’ x + b ’ ,\end{matrix}$$

where the updated weight W′=W*s′, the updated bias b′=b*s′−z*s′

In step P5, updating the activation function according to an inverse function of the linear mapping function.

Step P5 may be represented as f_{ACT}′=f_{ACT}∘f_{LM}⁻¹, where f_{ACT}′ denotes the updated activation function, f_{ACT} denotes the original activation function built according to the training dataset, and f_{LM}⁻¹ denotes the inverse function of the linear mapping function. Since the input of the activation function has already been adjusted by the linear mapping function, the activation function itself needs to be adjusted accordingly to ensure that the output yields the same results, i.e., f_{ACT}′(f_{LM}(x))=f_{ACT}(x). This significantly reduces errors caused by limited precision of the functional bootstrapping.

TABLE 1
where D denotes network depth, and L denotes
the number of fully connected layers.

| Model | D5L1 | D8L1 | D11L1 | D7L3 |
|---|---|---|---|---|
| Plain DNN Acc. | 60% | 72.5% | 77.5% | 80% |
| Secure DNN Acc. | 47.5% | 55% | 62.5% | 72.5% |
| wo LUT-Aware | | | | |
| Secure DNN Acc. | 57.5% | 70% | 75% | 80% |
| w/ LUT-Aware | | | | |
| (The present disclosure) | | | | |
| Total time | 881 s | 2092 s | 9458 s | 2558 s |

Please refer to Table 1. The inventors conducted a comprehensive experiment to validate the effectiveness of the LUT-aware model fine-tuning method proposed in the present disclosure using the CIFAR-10 dataset, which is more complex than the MNIST dataset. The experimental results show that our framework increases accuracy from 7.5% (as in D7L3) to 15% (as in D8L1) compared to the NN model without applying our method. Moreover, the fine-tuned NN models achieve accuracy comparable to the original ones (as in D7L3).

In view of the above, the operating system and method for fully homomorphic encryption neural network models proposed in the present disclosure inherit the advantages of linear operations in CKKS and functional bootstrapping in FHEW/TFHE. For fully homomorphic encryption neural network models, the CKKS scheme can be used for convolution operations, while the FHEW-TFHE functional bootstrapping scheme can be used for non-polynomial activation functions and bootstrapping. The present disclosure applies PEGASUS to convert between CKKS ciphertext and LWE ciphertext and proposes a lookup table-aware fine-tuning method to adjust model weights and activation functions, thereby improving the accuracy of fully homomorphic encryption neural network models.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. An operating method of a fully homomorphic encrypted neural network model, wherein the fully homomorphic encrypted neural network model includes a plurality of layers, and the method is performed by a processor and comprises:
for one of the plurality of layers, encrypting a plaintext input with a first encryption algorithm to generate a ciphertext vector;
performing a convolution operation according to the ciphertext vector to generate a result vector;
converting the result vector into a plurality of result ciphertexts adopting a second encryption algorithm;
inputting the plurality of result ciphertexts into an activation function to generate a plurality of encrypted activation values; and
repacking the plurality of encrypted activation values to generate an output vector adopting the first encryption algorithm.

2. The operating method of the fully homomorphic encrypted neural network model of claim 1, further comprising:
before performing the convolution operation according to the ciphertext vector to generate the result vector, for each of the plurality of layers, performing a training procedure for a plurality of times to generate a plurality of plaintext activation values, wherein the training procedure comprises:
performing the convolution operation on the plaintext input to generate a plaintext vector; and
inputting the plaintext vector into the activation function to generate one of the plurality of plaintext activation values;
determining a linear mapping range according to a range of the plurality of plaintext activation values;
for each of the plurality of layers, determining a linear mapping function according to the range of the plurality of plaintext activation values and the linear mapping range;
updating a weight of the convolution operation according to the linear mapping function; and
updating the activation function according to an inverse function of the linear mapping function.

3. The operating method of the fully homomorphic encrypted neural network model of claim 1, wherein the first encryption algorithm is Cheon-Kim-Kim-Song (CKKS) algorithm, and the second encryption algorithm is associated with Learn with errors (LWE).

4. The operating method of the fully homomorphic encrypted neural network model of claim 1, wherein the activation function is Rectified Linear Unit (ReLU).

5. An operating system of a fully homomorphic encrypted neural network model comprising:
a memory configured to store a plurality of instructions; and
a processor electrically connected to the memory to execute the plurality of instructions, wherein the plurality of instructions is configured to perform a plurality of operations on one of a plurality of layers of the fully homomorphic encrypted neural network model, and the plurality of operations comprises:
encrypting a plaintext input with a first encryption algorithm to generate a ciphertext vector;
performing a convolution operation according to the ciphertext vector to generate a result vector;
converting the result vector into a plurality of result ciphertexts adopting a second encryption algorithm;
inputting the plurality of result ciphertexts into an activation function to generate a plurality of encrypted activation values; and
repacking the plurality of encrypted activation values to generate an output vector adopting the first encryption algorithm.

6. The operating system of the fully homomorphic encrypted neural network model of claim 5, wherein the plurality of operations further comprises:
before performing the convolution operation according to the ciphertext vector to generate the result vector, for each of the plurality of layers, performing a training procedure for a plurality of times to generate a plurality of plaintext activation values, wherein the training procedure comprises:
performing the convolution operation on the plaintext input to generate a plaintext vector; and
inputting the plaintext vector into the activation function to generate one of the plurality of plaintext activation values;
determining a linear mapping range according to a range of the plurality of plaintext activation values;
for each of the plurality of layers, determining a linear mapping function according to the range of the plurality of plaintext activation values and the linear mapping range;
updating a weight of the convolution operation according to the linear mapping function; and
updating the activation function according to an inverse function of the linear mapping function.

7. The operating system of the fully homomorphic encrypted neural network model of claim 5, wherein the first encryption algorithm is Cheon-Kim-Kim-Song (CKKS) algorithm, and the second encryption algorithm is associated with Learn with errors (LWE).

8. The operating system of the fully homomorphic encrypted neural network model of claim 5, wherein the activation function is Rectified Linear Unit (ReLU).
